(19) United States
(12) Patent Application Publication
(10) Pub. No.: US 2011/0184959 A1
(43) Pub. Date: Jul. 28, 2011

(54) SUMMARIZING MEDICAL CONTENT WITH ITERATIVE SIMPLIFICATION RULES

(75) Inventors: John T. Maxwell, III, Cupertino, CA (US); Daniel G. Bobrow, Palo Alto, CA (US)

(73) Assignee: PALO ALTO RESEARCH CENTER INCORPORATED, Palo Alto, CA (US)

(21) Appl. No.: 12/692,910

(22) Filed: Jan. 25, 2010

(51) Int. Cl. G06F 17/30; G06F 3/048; G06N 5/02

(52) U.S. Cl. 707/754; 707/769; 715/780; 706/47; 707/755; 707/E17.002; 707/E17.016

(57) ABSTRACT

A method for generating a gloss of medical content. The method includes repeatedly applying, using a processor, a plurality of simplification rules to the medical content until the medical content is fully simplified. Thereafter, one or more target patterns having slots associated with ontologies are matched to one or more portions of the medical content and the one or more portions of the medical content are extracted. The one or more portions correspond to the gloss.

### BACKGROUND

The present exemplary embodiments relate to systems and methods for condensing text and other content. They find particular application in conjunction with medical content, such as medical abstracts, clinical trials and transcribed physician notes, and will be described with particular reference thereto. However, it is to be appreciated that the present exemplary embodiments are also amenable to other like applications.

There are over 18 million medical abstracts, and associated medical documents, on PubMed, and in 2008 alone, this number grew by more than 800,000. Medical abstracts often include conclusions useful to people needing to understand pertinent research in, and the state of the art of, a particular medical topic. However, understanding the potential import of a medical document based upon its medical abstract is often difficult and time consuming because the conclusions are often wordy, with many hedges. Consequently, it would be advantageous to have systems and/or methods of generating a gloss of a medical abstract so as to ease one's determination as to whether to read an associated medical document.

In a related problem, current systems for searching medical documents often depend upon keywords to return a list of relevant medical documents. However, such systems often require one to look through the medical documents to determine the relevance of the keywords. Additionally, keyword searching often lacks the ability to effectively find relationships among keywords, such as diseases and/or treatments. For example, if one wanted to find all medical documents that mention treatment X producing less disease Y, one would have a difficult time finding a combination of keywords applicable to all the medical documents discussing said relationship. Accordingly, it would be advantageous to have systems and/or methods for more effectively searching medical documents and/or determining the relevance thereof.

Along the same line, many medical documents pertain to clinical trials, which provide a wealth of information to medical researchers. However, search systems generally lack the ability to extract the salient points from the clinical trials and to filter search results based upon the salient points. Consequently, it would be advantageous to have systems and/or methods capable of extracting the salient points from clinical trials and/or filtering search results according to the extracted salient points.

Even assuming one can adequately find relevant medical documents, with the large volume of medical documents and the rapid advancements being made in the field of medicine, it is often impractical for researchers to review all of the medical documents addressing a particular topic. Consequently, it is common for parties to perform reviews summarizing the state of the art on a particular topic. Today, about 10% of medical documents on PubMed pertain to reviews. However, as should be appreciated, because of the rapidly changing nature of the state of the art, reviews are quickly outdated. Thus, it would be advantageous to have systems and/or methods capable of automatically reviewing the state of the art and extracting the salient points into a review.

Related art uses the PICO framework to ameliorate some of the concerns noted above. The PICO framework formalizes information into questions comprised of Patient/Problem, Intervention, Comparison, and Outcomes. For more information, attention is directed to Dina Demner-Fushman, “COMPLEX QUESTION ANSWERING BASED ON A SEMANTIC DOMAIN MODEL OF CLINICAL MEDICINE”, available at http://www.lib.umd.edu/drum/bitstream/1903/4098/1/umi-umd-3884. pdf.

The present application contemplates new and improved systems and/or methods which may be employed to mitigate the above-referenced problems and others.

### BRIEF DESCRIPTION

According to one aspect of the application, a method for generating a gloss of medical content is provided. The method includes repeatedly applying, using a processor, a plurality of simplification rules to the medical content until the medical content is fully simplified. Thereafter, one or more target patterns are matched to one or more portions of the medical content and the one or more portions of the medical content are extracted. The one or more portions correspond to the gloss.

According to another aspect of the application, a system for searching one or more medical documents in response to a search request from a requester is illustrated. The one or more medical documents have glosses associated therewith and the glosses match one or more target patterns having one or more slots. The system includes an interface provisioned to exchange communications between the system and the requester over a communications network. The interface receives the search request from the requester over the communications network, where the search request specifies search criteria slot-wise according to the one or more slots. The system further includes a search component provisioned, using a processor, to search the glosses of the one or more medical documents and identify glosses matching the search criteria of the search request.

According to another aspect of the application, a user interface for searching one or more medical documents is provided. The one or more medical documents have glosses associated therewith and the glosses match one or more target patterns having one or more slots. The user interface is visually rendered on a display using a processor. The user interface includes one or more input fields associated with the one or more slots of the one or more target patterns. Additionally, the user interface is provisioned to allow the generation of search criteria on a slot-wise basis using the one or more input fields.

### BRIEF DESCRIPTION OF THE DRAWINGS

FIG. 1 is block diagram of a method for generating a gloss of medical content;

FIG. 2 is an illustration of a simplification rules database;

FIG. 3 is an illustration of an ontology database;

FIG. 4 is a block diagram of a system for searching medical documents having glosses generated according to the method of FIG. 1;

FIG. 5 is an illustration of a medical documents database;

FIG. 6 is an illustration of a network environment in which the system of FIG. 4 may be employed; and

FIG. 7 is an illustration of a user interface for searching medical documents slot-wise.

### DETAILED DESCRIPTION

The present systems and methods disclosed herein pertain to condensing medical content, such as medical abstracts, clinical trials and transcribed physician notes. By applying a set domain specific simplification rules to medical content, one can normalize the medical content. Thereafter, one can easily extract salient points to generate a gloss of the medical content.

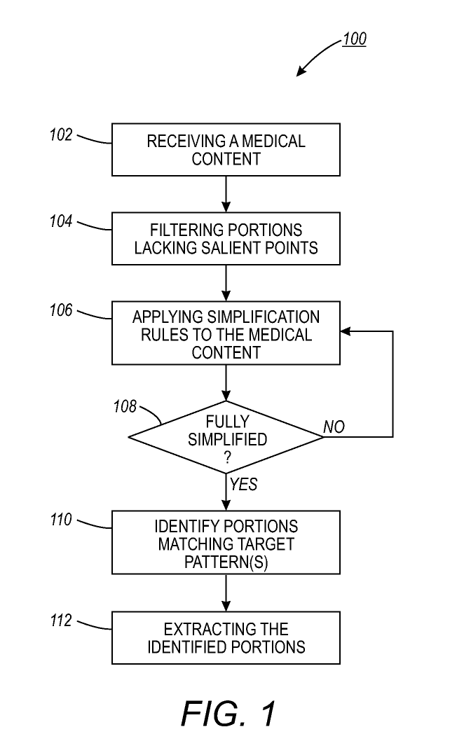

With reference to FIG. 1, a method 100 of generating a gloss of medical content is illustrated. A gloss includes one or more salient points of medical content, such as conclusions and facts, and, in certain embodiments, summarizes the medical content. The method 100 includes receiving medical content (Action 102), optionally filtering portions of the medical content lacking salient points (Action 104), applying simplification rules to the medical content (Action 106), determining if the medical content is fully simplified (Action 108), identifying portions of the medical content matching one or more target patterns (Action 110), and extracting the identified portions of the medical content (Action 112).

The method 100 begins by receiving medical content (Action 102). The medical content is text having one or more salient points therein. In certain embodiments, the one or more salient points are conclusions and/or facts. Further, in certain embodiments, the medical content is one or more of a medical abstract, a clinical trial, transcribed physician notes, a string of words, and one or more dependency structures. A dependency structure may be a word-level, phrase-level, or any other type of dependency structure. Further, although there are numerous ways to define dependency structures, in certain embodiments the f-structures of the Lexical Functional Grammar framework are used. For more information pertaining to Lexical Functional Grammar, attention is directed to MARY DALRYMPLE, 35 SYNTAX AND SEMANTICS, LEXICAL FUNCTIONAL GRAMMAR (Academic Press 2001), incorporated herein by reference in its entirety. A medical abstract is associated with a medical document discussing one or more medical topics and generally summarizes the contents of the associated medical document. In certain embodiments, the medical abstract includes one or more conclusions. A clinical trial is a research study using test subjects (e.g., test animals, human volunteers, etc.) to address specific health questions. A clinical trial may include a medical abstract and/or a discussion of one or more salient points of the clinical trial, such as, but not limited to, eligibility criteria and genetic markers. As with a medical abstract, a clinical trial, in certain embodiments, includes one or more conclusions.

After receiving the medical content (Action 102), the medical content is optionally filtered to remove portions thereof lacking salient points (Action 104). A portion may include the entire medical content or a subset of the medical content. Additionally, in certain embodiments, portions of the medical content refer to sentences or clauses. In one embodiment, filtering entails performing a simple keyword search of the medical content to identify portions having words or phrases typically associated with salient points, such as ‘thus’, ‘in conclusion’, ‘accordingly’, etc. In another embodiment, filtering entails temporarily augmenting medical content presented in dependency structure form to a string of words and performing a keyword search as noted above to identify portions thereof having salient points. One tool for accomplishing this is XLE, a parser for Lexical Functional Grammars, available at http://www2.parc.com/isl/groups/nltt/xle/. XLE allows one to convert between dependency structures and strings of words. Notwithstanding the aforementioned embodiments, the skilled artisan will appreciate that other methods of identifying salient portions are equally amenable. Thereafter, portions identified as lacking salient points are filtered, or otherwise ignored, for the duration of the method 100. This advantageously reduces the amount of time necessary to carry out the remainder of method 100.

Regardless of whether the medical content is filtered (Action 104), simplification rules are applied to the medical content next (Action 106). The simplification rules are applied in sequential order, random order, or any other order pattern. Simplification rules map an original phrase or word to a simplified phrase or word, where the simplified phrase or word captures the essences of the original phrase or word. In alternative embodiments where the medical content is in dependency structure form, the simplification rules map an original dependency structure to a simplified dependency structure, where the simplified dependency structure captures the essence of the original dependency structure. Simplification rules, in certain embodiments, further include slots associated with an ontology database. A slot will match any word or phrase associated with the ontology of the slot, thereby increasing the versatility of the simplification rules. Thus, for example, a simplification rule having a slot for DISEASE will match any disease, such as cancer, in the ontology associated with the slot.

In one embodiment, the simplification rules are individually generated prior to operation of method 100. In certain embodiments, it is contemplated that hundreds or thousands of simplification rules may be necessary. However, this is not viewed as overly onerous and it advantageously ensures that the resulting glosses focus on the desired salient points. As will become clearer, the simplification rules are chosen so as to normalize the wording of salient points in the medical content. For example, suppose “X is greater than Y” is a salient point. One can say “X is greater than Y” in a number of other ways, including “Y is less than X”, “X is larger than Y”, “Y is smaller than X”, etc. In this example, simplification rules are generated to normalize any variation of “X is greater than Y” so once the simplification rules are applied any variation reads as “X is greater than Y”. In alternative embodiments, the simplification rules are automatically generated.

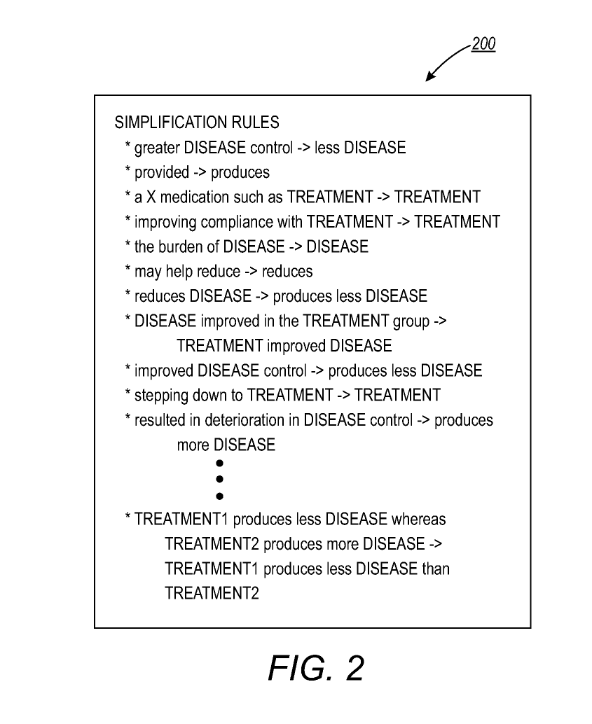

With reference to FIG. 2, a simplification rule database 200 is illustrated. The simplification rule database 200 includes a plurality of simplification rules (each identified with “*”). However, it should be appreciated that notwithstanding the simplification rules shown, the simplification rule database 200 may include other simplification rules. Further, as shown, a simplification rule takes the form of “X ->Y”, where words or phrases matching “X” are rewritten to “Y”. Thus, taking the last simplification rule, for example, instances of:
“TREATMENT1 produces less DISEASE whereas TREATMENT2 produces more DISEASE”
   are rewritten to
“TREATMENT1 produces less DISEASE than TREATMENT2”.

Therein, TREATMENT1 and TREATMENT2 correspond to a slot and are associated with an ontology of treatments. Likewise, DISEASE corresponds to a slot and is associated with an ontology of diseases. A slot corresponds to a variable portion of a rewrite rule and is associated with an ontology. Notwithstanding that slots for DISEASE and TREATMENT are illustrated, other slots and corresponding ontologies are amenable. For example, a slot and corresponding ontology for regimens may be employed. Further, in certain embodiments, “X” may correspond to a regular expression optionally using slots.

When the medical content is in dependency structure form, the simplification rules are first converted to dependency structures and then used to simplify the dependency structures of the medical content. As noted above, XLE may be used to convert between a string of words and dependency structures. A first dependency structure is matched to a second dependency structure by determining whether the second dependency structure includes the same arrangement of nodes and edges (i.e., structure) as the first dependency structure. For example, suppose the dependency structure for “stepping down to TREATMENT” is the same as “stepping down quickly to Advil”, other than the latter having an extra branch and node corresponding to “quickly” extending from the root node. The former dependency structure would match to the larger, latter dependency structure since its arrangement of nodes and edges would exist within latter dependency structure notwithstanding the extraneous information corresponding to “quickly”. Thus, as should be appreciated, using dependency structures advantageously allows extraneous information to be ignored when rewriting medical content.

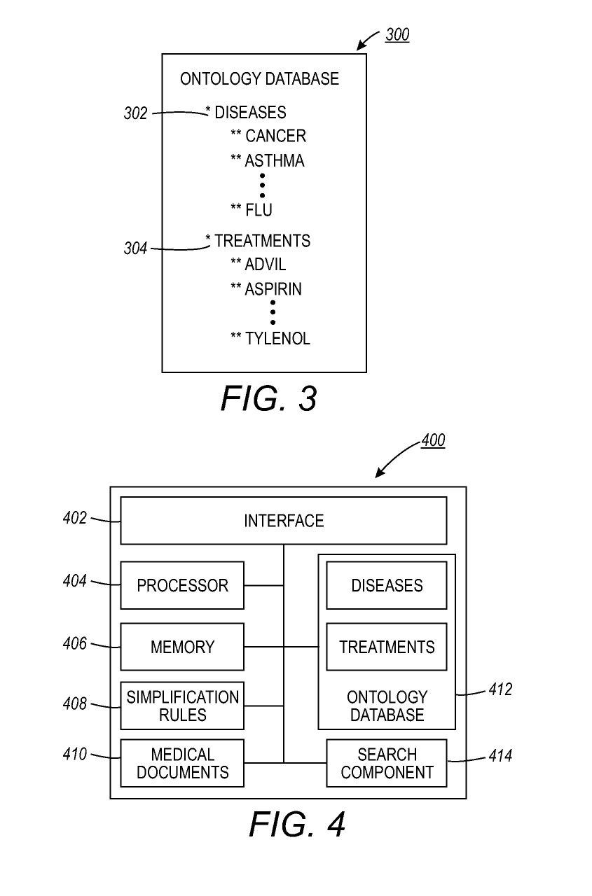

With reference to FIG. 3, an ontology database 300 associated with the simplification rule database 200 of FIG. 2 is illustrated. As shown, the ontology database includes ontologies 302, 304 for diseases and treatments (each identified with “*”). With respect to diseases 302 and treatments 304, a plurality of diseases (identified with “**”) and a plurality of treatments (identified with “**”), respectively, are illustrated. Since the slots of the simplification rules of the simplification rule database 200 are associated with the ontology database 300, the simplification rules will be applied as if the slots were any one of the words or phrases in their associated ontologies. Naturally, DISEASE, DISEASE1, DISEASE2, etc. in FIG. 2 match to the diseases in the DISEASES ontology 302. Likewise, TREATMENT, TREATMENT1, TREATMENT2, etc. in FIG. 2 match to the treatments in the TREATMENTS ontology 304. Thus, for example, a slot for DISEASE in a simplification rule will match to any word or phrase in its associated ontology; in this instance, cancer, the flu, asthma and any other diseases that may be in the ontology 302. Although not shown, in certain embodiments, an ontology for regimens may be included within the ontology database 300.

Referring back to FIG. 1, after the simplification rules are applied (Action 106), a determination is made as to whether the medical content is fully simplified (Action 108). This determination is based upon whether or not any of the simplification rules were applied in the preceding action (Action 106). If simplification rules were applied in the preceding action (Action 106), then the medical content is not fully simplified, whereby the simplification rules are applied again. This is repeated until the medical content is fully simplified. However, if simplification rules were not applied in the preceding action (Action 106), then the medical content is fully simplified.

As should be appreciated, this repeated application of the simplification rules may prove time consuming. However, as will be seen, by expanding the simplification rules into combined and/or more complex simplification rules and/or arranging the simplification rules in order of dependency, the effect of this repeated application may be avoided or reduced. In certain embodiments, these optimizations are performed before the method 100 is carried out.

With respect to expanding the simplification rules into combined and/or more complex simplification rules, the simplification rules are expanded into all possible rewrite combinations. In expanding the simplification rules into all possible rewrite combinations, the simplification rules are combined so that a single pass through the combined and/or more complex simplification rules would carry out all of the simplifications of the medical content that the original simplification rules would perform in numerous passes. For information pertaining to the process of expanding the simplification rules into combined and/or more complex simplification rules, attention is directed to U.S. Pat. No. 5,594,641 for “Finite-State Transduction Of Related Word Forms For Text Indexing And Retrieval,” by Kaplan et al., incorporated herein by reference in its entirety. Thus, as should be appreciated, expanding the simplification rules into complex simplification rules reduces the amount of time needed to carry out the method 100, at the cost of an increase in the amount of space needed to store the simplification rules.

With respect to arranging the simplification rules in order of dependency, the simplification rules may be arranged from the least dependent simplification rule to the most dependent simplification rule. Namely, a simplification rule depending upon another simplification rule is arranged after the simplification rule upon which it depends. A simplification rule is dependent upon another simplification rule if the input of the simplification rule is dependent upon the output of the other simplification rule. As noted above, simplification rules can be thought of as taking the form of “X->Y”, where portions of medical content matching “X” are rewritten to “Y”. “X” corresponds to the input of a simplification rule and “Y” corresponds to an output of a simplification rule. One method of accomplishing this ordering is to generate a graph identifying dependencies between the simplification rules, where vertices correspond to simplification rules and edges correspond to dependencies. Thereafter, the simplifications rules are arranged in the order they appear in a breadth first graph traversal. As should be appreciated, this arrangement is limited to the extent that the dependencies among simplifications rules are acyclic.

One solution for expanding the simplification rules to combined and/or more complex simplification rules and/or arranging the simplification rules in order of dependency is by application of Finite State Tools, such as the Xerox Finite State Tool (XFST) as described in the articles “Xerox Finite-State Tool”, by Lauri Karttunen, Tomás Gaál and André Kempe (version 5.9.0) Copyright 1997, and Kaplan and Kay, 1994, “Regular Models of Phonological Rule Systems, Computational Linguistics, 20:3, pages 331-378, both hereby incorporated by reference in their entirety.

To illustrate the method thus far, the simplification rules of FIG. 2 are hereafter applied to medical content defined by the following conclusory sentence from a medical abstract:
“The results of this open-label, randomized study showed that SFC provided greater asthma control than CC in the management of persistent asthma.”

Applying the “greater DISEASE control->less DISEASE” simplification rule rewrites the subject sentence to:
“The results . . . showed that SFC provided less asthma than CC . . ”

As should be appreciated, this rewrite presupposes that DISEASE is connected with an ontology having asthma therein. Further, the simplification rule only rewrites the portion of the subject sentence it matches to, whereby any portions of the subject sentence not matched remain unchanged.

Thereafter, applying the “provided->produces” simplification rule to the foregoing rewritten sentence further simplifies the subject sentence to:
“This results . . . that SFC produces less asthma than CC . . . ”

Since no further simplification rules apply, the medical content is fully simplified. That is to say, because not more simplification rules match, the medical content is fully simplified.

Assuming the medical content to be fully simplified, portions of the medical content are matched to one or more target patterns (Action 110). A portion may include the entire medical content or a subset of the medical content. A target pattern identifies a salient point of the medical content and facilitates the structured extraction thereof. As with the simplification rules, a target pattern may include one or more slots associated with an ontology database. Further, when the medical content is in dependency structure form, a target pattern is converted to dependency structure form for matching to the medical content. As noted above, XLE converts strings of words to dependency structures, whereby XLE may be employed to convert target patterns to dependency structures. In certain embodiments, the one or more target patterns include a target pattern of “TREATMENT1 produces more/less DISEASE than TREATMENT2” and/or “REGIMEN was recommended to patient”. The former target pattern includes slots associated with treatment and disease ontologies and the latter target pattern includes a slot associated with a regimen ontology. As should be appreciated, the simplification rules are chosen to normalize the salient points of the medical content, so the one or more target patterns are more readily matched to portions of the medical content.

The identified portions of the medical content are thereafter extracted (Action 112). These extracted portions define the gloss of the medical content and match the one or more target patterns discussed above. For example, if “TREATMENT1 produces more/less DISEASE than TREATMENT2” was matched to a portion of the medical content, the portion would be extracted, whereby the gloss would include a phrase following the target pattern. This phrase might be:
“Aspirin produces more cancer than Advil”.
   Likewise, if “REGIMEN was recommended to patient” was matched to a portion of the medical content, the portion would be extracted, whereby the gloss would include a phrase following the target pattern. This phrase might be:
“Tylenol was recommended to the patient”.

The method 100 may optionally be expanded upon to generate reviews summarizing the state of the art on a particular medical topic. Namely, glosses of the most recent medical documents addressing a particular medical topic could be generated and combined into a review. The medical documents could be identified using traditional searching systems or according to the search system discussed in FIG. 4 below. Since the glosses contain salient points of the medical documents, generating the review simply entails combining the glosses. The medical documents may include clinical trials and/or other reviews pertaining to the particular medical topic.

With reference to FIG. 4, a system 400 for searching one or more medical documents in response to a search request from a requester is illustrated. The system 400 includes an interface 402, processor 404, memory 406, simplification rules database 408, a medical documents database 410, an ontology database 412 and a search component 414. The interface 402 exchanges communications via a communication network (not shown), such as the Internet, and receives the search request from the requester. The search request specifies search criteria slot-wise according to one or more slots associated with the one or medical documents. The processor 404 may be a general purpose processor, a microcontroller, an ASIC, an FPGA, or other like device. The processor is configured to operate software performing the various aspects of the present application, such that the processor is configured as a machine specific to the operations of the present application.

The simplification rules database 408 includes one or more simplification rules. The one or more simplification rules are substantially as described in connection with FIG. 1. Thus, as should be recalled, the simplification rules may include one or more slots, where each slot is associated with an ontology. The simplification rules database 408 may, for example, be as shown in FIG. 2. Further, the simplification rule database 408 may be external or internal to the system 408. Alternatively, the simplification rules database 408 may be distributed locally and/or remotely.

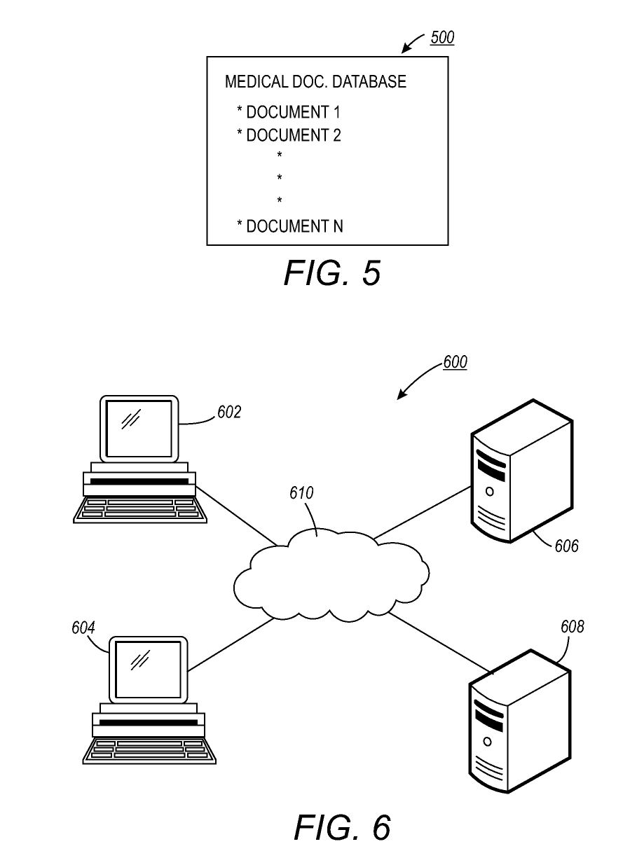

The medical documents database 410 includes one or more medical documents. The medical documents may be, for example, clinical trials, and each of the one or more medical documents includes a medical abstract. Alternatively, or in addition, the medical documents may be transcribed physician notes. Further, each of the one or more medical documents has glosses associated therewith. Glosses are substantially as described above and each gloss includes salient points of its associated medical document. The glosses of the one or more medical documents may be limited to the associated medical abstracts or cover the entirety of the associated medical documents. Additionally, the glosses for the one or more medical documents are generated according to the method 100 of FIG. 1. Accordingly, the glosses match one or more target patterns having one or more slots. With reference to FIG. 5, a medical database 500 having a plurality of medical documents is illustrated. Further, as with the simplification rules database 408, the medical documents database 410 may be internal or external to the system 408 and/or distributed locally and/or remotely.

The ontology database 412 contains ontologies for slots of the simplification rules of the simplification rules database 408 and/or the slots of the target patterns used to extract salient points from the one or more medical documents. The ontology database 412 is substantially as described in connection with FIG. 1. Further, FIG. 3 illustrates an ontology database having ontologies 302, 304 for diseases and treatments. As with the other databases disclosed heretofore, the ontology database may be external, internal or distributed locally and/or remotely.

The search component 414, using the processor 404 and the memory 406, searches the glosses of the one or more medical documents in the medical documents database 410. As noted above, each of the medical documents includes a gloss comprised of salient points of the medical document. Further, as described in connection with FIG. 1, the salient points comprising the glosses match target patterns, which may contain slots. The search component 414 searches for glosses matching the slot-wise search criteria specified in the search request. Slot-wise search criteria define one or more slots associated with one or more target patterns of the one or more medical documents, thereby limiting the one or more target patterns. Thus, the search component 414 searches the glosses of the one or more medical documents for portions matching these limited target patterns.

As noted above, target patterns identify salient points, such as eligibility criteria and genetic markers, of a medical document. Consequently, one should appreciate that the search is conducted based upon salient points of the one or more medical documents.

Taking the target pattern of “TREATMENT1 produces more/less DISEASE than TREATMENT2”, for example, a search request might define TREATMENT1 to be Advil. The search component 414 would then find all the medical documents whose associated glosses match “Advil produces more/less DISEASE than TREATMENT2”. As should be appreciated, the portion of the target pattern reciting “more/less” matches to either “more” or “less” and can be analogized to a slot in that it is variable based upon the ontology comprised of “more” and “less”. Further, the slot for TREATMENT1 is replaced by a specifically defined value, in this case “Advil”, provided by the requester. In view of the foregoing, by searching based upon the slots of target patterns after glosses have been generated, relations between keywords can be effectively searched.

Notwithstanding that the search request includes slot-wise search criteria, the search request may further include traditional search criteria. Such other search criteria might include keywords, date ranges, etc. This additional search criteria may be used to further limit search results or as a fallback should the slot-wise search fail to return any results.

The search component 414 additionally generates glosses for medical documents not having glosses while searching. These glosses are generated according to the method 100 of FIG. 1. However, it should be appreciated, that the glosses of the medical documents are preferably generated before any searching is commenced. Additionally, the search component 414 returns the search results to the requester via the interface 402 after the search is completed. In doing this, it may include, for example, the medical abstracts and/or the portions of the glosses matching the slot-wise search criteria.

With reference to FIG. 6, a network environment 600 in which the system 400 of FIG. 4 might be employed is illustrated. The network environment 600 includes a plurality of terminals 602, 604 and a plurality of servers 606, 608 interconnected by a communications network 610. The terminals 602, 604 are communications devices capable of communication over a communications network, and, in certain embodiments, the terminals 602, 604 are one of the following: personal computers, mobile devices, and other like devices. Notwithstanding that two terminals 602, 604 are illustrated, any number greater than zero may be employed. In certain embodiments, the communications network 610 is the Internet. However, other communications networks 610 are equally amenable to the teachings herein.

The servers 606, 608 are also communications devices capable of communicating over a communications network. In certain embodiments, the system 400 of FIG. 4 may be employed within any one of the servers 606, 608 or distributed between the servers 606, 608. In a distributed arrangement, for example, the medical documents database 410 of the system 400 of FIG. 4 may be employed within the first server 606 and the remaining components of the system 400 of FIG. 4 may be employed within the second server 608. Notwithstanding that FIG. 6 only illustrates two servers 606, 608, it should be appreciated that additional servers may be employed for a distributed arrangement.

Referring back to FIG. 4 and assuming the system 400 is employed within the first server 606 of FIG. 6, the system 400 receives a search request from one of the terminals 602, 604 over the communications network 610. The search request specifies search criteria on a slot-wise basis, which entails defining one or more slots of one or more target patterns. Search criteria may further limit the search to certain portions of the medical documents, such as medical abstracts, and/or include traditional search criteria, such as keywords, date ranges, etc. Traditional search criteria may also be used as a fallback if the slot-based search fails and/or returns few results.

After receiving a search request, the medical documents in the medical documents database 410 are searched. In one embodiment, each medical document is searched to determine whether it matches the search criteria. Searching may entail applying the simplification rules and extracting the salient points of the medical documents. However, in other embodiments, the simplification rules are applied, and the salient points extracted, before any searching is conducted, whereby the simplifications need not be applied for each and every medical document while searching.

After the search of the medical documents database 410 is complete, the search results are returned to the requesting terminal. Although there are numerous ways to return the search results, in certain embodiments, the portions of the search results matching the target patterns used are returned. Additionally, or in the alternative, the portions of the search results matching keywords may be returned.

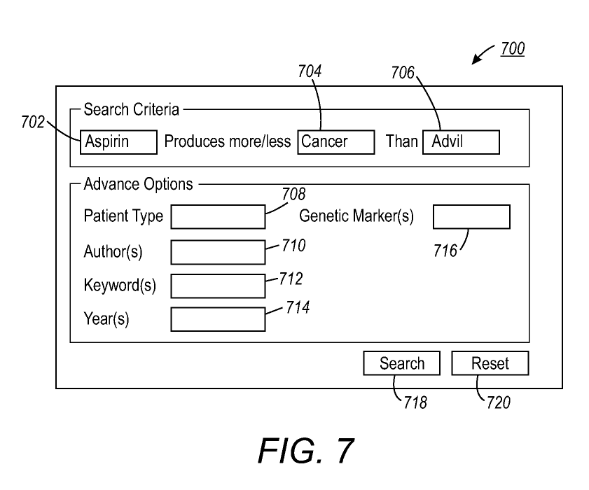

With reference to FIG. 7, a user interface 700 for searching medical documents is illustrated. In certain embodiments, the user interface 700 is visually rendered on a display device using a processor programmed for such use. The display device may be, for example, an LCD display, a plasma display, a CRT display, an LED display, or any other like display. Further, the user interface 700 may be web based and/or receive user input via a user input device, such as a mouse and/or keyboard.

The user interface 700 includes input fields 702, 704, 706 for defining slots of a target pattern and generating slot-wise search criteria. As illustrated, the input fields 702, 704, 706 correspond to the slots of a target pattern of “TREATMENT1 produces more/less DISEASE than TREATMENT2”. In certain embodiments, the user interface may include additional input fields corresponding to different target patterns, such as the target pattern of “REGIMEN was recommended to patient”. It should be appreciated that “more/less” is used to match to either “more” or “less”.

The user interface further includes input fields 708, 710, 712, 714, 716 for other search criteria, such as patient type, author, keyword, year, and genetic marker. The input fields 710, 712, 714 associated with authors, keywords and years are traditional search criteria. The input fields 708, 716 associated with patient type and genetic markers are associated with target patterns. However, unlike the target pattern associated with input fields 702, 704 and 706, these target patterns only include a single slot and do not account for relationships between slots.

In operation, a user specifies input into one or more of the input fields 702, 704 and 706. In doing so, the one or more slots associated with the one or more input fields 702, 704, 706 are replaced by specifically defined values provided by the user. Accordingly, if the user specifies Aspirin in input field 702, for example, the slot associated with the input field 702 is replaced with “Aspirin”, thereby defining a limited target pattern that will only match medical documents having Aspirin in the location previously occupied by the slot associated with the input field 702. This limited target pattern forms partially or wholly the slot-wise search criteria included with every search request, as noted above. The user may further specify traditional search criteria, such as authors, keywords, and years. Moreover, the user may specify search criteria, such as genetic markers and patient type. These criteria are of particular importance in clinical trials and correspond to salient points of the clinical trial.

After the user defines their search criteria, they may search by selecting the search button 718 of the user interface 700, whereby the user input from the user interface 700 is used to generate a search request. In certain embodiments, the search is conducted locally. However, in other embodiments, the search request is transferred via a communications network to a remote server. In such embodiments, the remote server performs the search based upon the search request and returns the results. Notwithstanding whether the search is performed locally or remotely, the search results are displayed on the user interface. The user interface also includes a reset button 720 to clear the input fields.

It will be appreciated that various of the above-disclosed and other features and functions, or alternatives thereof, may be desirably combined into many other different systems or applications. For example, in some embodiments, the exemplary methods, discussed above, the systems employing the same, and so forth, of the present application are embodied by a storage medium storing instructions executable (for example, by a digital processor). The storage medium may include, for example: a magnetic disk or other magnetic storage medium; an optical disk or other optical storage medium; a random access memory (RAM), read-only memory (ROM), or other electronic memory device or chip or set of operatively interconnected chips; an Internet server from which the stored instructions may be retrieved via the Internet or a local area network; or so forth.

In view of the foregoing, it is to be understood that TREATMENT1, TREATMENT2, DISEASE and REGIMEN refer to a first type of treatment, a second type of treatment, a type of disease, and a patient treatment regimen, respectively. Also, while the present discussion focused mainly on the use of the present concepts in the medical field, it is to be understood such use could be expanded to other areas, reports, news reports, such as financial news, political news, repair tips (e.g., copier repair tips) among others.

It will further be appreciated that various of the above-disclosed and other features and functions, or alternatives thereof, may be desirably combined into many other different systems or applications. For example, in some embodiments, the exemplary methods, discussed above, the systems employing the same, and so forth, of the present application are embodied by a storage medium storing instructions executable (for example, by a digital processor). The storage medium may include, for example: a magnetic disk or other magnetic storage medium; an optical disk or other optical storage medium; a random access memory (RAM), read-only memory (ROM), or other electronic memory device or chip or set of operatively interconnected chips; an Internet server from which the stored instructions may be retrieved via the Internet or a local area network; or so forth.

Also, it will be appreciated that various presently unforeseen or unanticipated alternatives, modifications, variations or improvements therein may be subsequently made by those skilled in the art which are also intended to be encompassed by the following claims.

What is claimed is:

1. A method for generating a gloss of medical content, said method comprising:
repeatedly applying, using a processor, a plurality of simplification rules to the medical content until the medical content is fully simplified;
matching one or more target patterns to one or more portions of the medical content; and
extracting the one or more portions of the medical content, wherein the one or more portions correspond to the gloss.

2. The method of claim 1, wherein the medical content is one of a medical abstract, a clinical trial, and transcribed physician notes.

3. The method of claim 1, wherein the one or more target patterns identify one or more salient points of the medical content.

4. The method of claim 3, wherein the one or more salient points of the medical content include eligibility criteria and/or genetic markers.

5. The method of claim 1, further comprising parsing the medical content and identifying portions thereof containing conclusions, wherein the medical content is filtered to include only the identified portions.

6. The method of claim 1, wherein a target pattern of the one or more target patterns includes one or more slots linked to an ontology database.

7. The method of claim 1, further comprising combining the simplification rules into complex simplification rules and/or arranging the simplification rules in order of dependency.

8. The method of claim 1, wherein the one or more target patterns includes a target pattern of TREATMENT1 produces more/less DISEASE than TREATMENT2 and/or a target pattern of REGIMEN was recommended to patient.

9. The method of claim 1, wherein the medical content is comprised of one or more dependency structures.

10. The method of claim 9, wherein the plurality of simplification rules and/or one or more target patterns rules are converted to dependency structures.

11. A system for searching one or more medical documents in response to a search request from a requester, wherein said one or more medical documents have glosses associated therewith, wherein the glosses match one or more target patterns having one or more slots, said system comprising:
an interface provisioned to exchange communications between the system and the requester over a communications network, wherein the interface receives the search request from the requester over the communications network, wherein the search request specifies search criteria slot-wise according to the one or more slots; and
a search component provisioned, using a processor, to search the glosses of the one or more medical documents and identify glosses matching the search criteria of the search request.

12. The system of claim 11, wherein the search criteria includes a target pattern of the one or more target patterns, wherein a slot of the target pattern is defined.

13. The system of claim 11, wherein a target pattern of the one or more target patterns is TREATMENT1 produces more/less DISEASE than TREATMENT2 and/or REGIMEN was recommended to patient.

14. The system of claim 11, wherein the search component is provisioned to narrow search space according to keywords.

15. The system of claim 11, wherein the system includes a database having a plurality of simplification rules specific to the one or more medical documents.

16. The system of claim 11, wherein the glosses include salient points of at least one of a clinical trial, a medical abstract and transcribed physician notes.

17. The system of claim 11, wherein the one or more slots are associated with an ontology database.

18. A user interface for searching one or more medical documents, wherein said one or more medical documents have glosses associated therewith, wherein the glosses match one or more target patterns having one or more slots, wherein said user interface is visually rendered on a display using a processor, said user interface comprising:
one or more input fields associated with the one or more slots of the one or more target patterns, wherein the user interface is provisioned to allow the generation of search criteria on a slot-wise basis using the one or more input fields.

19. The user interface of claim 18, said user interface comprising one or more input fields for limiting the search criteria based upon keywords.

20. The user interface of claim 18, wherein the one or more target patterns include a target pattern of TREATMENT1 produces more/less DISEASE than TREATMENT2 and/or a target pattern of REGIMEN was recommended to patient.
